(19) United States
(12) Patent Application Publication
(10) Pub. No.: US 2024/0225033 A1
(43) Pub. Date: Jul. 11, 2024

(54) PRODUCT CARRIER AND TRANSPORT DEVICE

(71) Applicant: Bühler GmbH, Beilngries (DE)

(72) Inventors: Achim KLEIN, Beilngries (DE); Kay HAUSCHULZ, Sankt Augustin (DE); Stephen CHAPMAN, Pond Garth, York (GB)

(21) Appl. No.: 18/559,726

(22) PCT Filed: May 11, 2022
(86) PCT No.: PCT/EP2022/025220

§ 371 Date: Nov. 8, 2023

(30) Foreign Application Priority Data
May 11, 2021 (EP) 21173309.2

(51) Int. Cl. A23G 1/26; B65G 61/00

(52) U.S. Cl. CPC A23G 1/26; B65G 61/00; B65G 2201/0202

(57) ABSTRACT

A product carrier for transporting food products in a transport device, and to a transport device. The product carrier has an upper side for loading and/or inserting products and an underside opposite the upper side. The product carrier has a rectangular basic shape with longitudinal sides which have a length in a longitudinal direction, and with width sides which have a width in a width direction perpendicular to the longitudinal direction. The product carrier has, on the longitudinal sides, mutually-opposing longitudinal-edge strips, each of which has a drive aperture.

The invention relates to a product carrier for transporting food products, and in particular chocolate products, in a transport device, and to a transport device.

It is known to use product carriers for producing chocolate products or similar products which substantially consist of a rectangular component which is preferably made of plastic, wherein apertures or alveoli are provided in the surface, into which apertures a food mass is cast. The subsequent processing takes place, for example, in a cooling system or in other processing stations which are known from the prior art.

The product carriers can be transported along a plant for producing food products—for example, with the aid of two chains arranged parallel to one another. Such chains can be equipped with protruding drivers, which come into contact with the product carriers, in order to pull or push the product carriers along the line.

Alternatively, it can be provided to convey the product carriers with a push bar arrangement. The push bars also have drivers for pushing the product carriers, but convey the product carrier only along a limited push path, after which the product carrier is taken by the next drivers—optionally, a subsequent push bar arrangement.

At the processing stations, the product carriers are typically taken by a transport system of the respective processing station—for example, a lifting table, a push bar arrangement, a chain drive, or a robot. The transfer must be made in such a way that the product is not damaged.

In the processing stations, which can be designed as modules, for example, the transport speed can vary. If a product carrier is taken or delivered by a processing station, it may therefore be necessary to adjust the transport speed. The plant can have buffer zones for this purpose.

From EP0661002 A1, a product carrier is known which has projections on the underside which positively engage in active contact with the threads of a threaded screw.

For storage, it is useful if the product carriers are stackable, and maximum stability of the stack is ensured. As shown in EP0661002 A1 or WP2019/081716 A1, the product carrier can have step-like apertures in which feet of the product carrier engage. Dirt can collect in these stepped apertures.

The object of the above invention is to avoid the disadvantages of the known prior art, and to provide a product carrier and a transport device by means of which variable and at the same time precise transport of the product carriers is made possible.

The object is achieved with the features of the independent claims.

A product carrier according to the invention is suitable for transporting food products, and in particular chocolate products, in a transport device—in particular, in a plant for producing food products.

The product carrier has an upper side for loading and/or inserting products and an underside opposite the upper side.

The product carrier has a rectangular basic shape with longitudinal sides which have a length in a longitudinal direction, and with width sides which have a width perpendicular to the longitudinal direction. The length can be smaller than the width.

The longitudinal sides therefore extend in the longitudinal direction, and the width sides extend in a width direction perpendicular thereto.

The longitudinal direction usually corresponds to the direction in which the product carriers are predominantly transported in a transport system, i.e., the transport direction.

The product carrier has, on the longitudinal sides, mutually-opposing longitudinal-edge strips, each of which has a drive aperture.

The longitudinal-edge strips preferably enclose a right angle with the upper side.

The drive apertures of the two longitudinal-edge strips are open in a direction extending away from the upper side.

The drive apertures each have a longitudinal extent of greater than 50%, and preferably greater than 80%, of the length of the product carrier. Accordingly, just one drive aperture is provided in each longitudinal-edge strip.

The drive apertures have stop edges in and counter to the transport direction.

The drive apertures are preferably designed such that the edge of the drive aperture encloses an angle between 85° and 95° with the lower edge of the longitudinal-edge strip.

A driver of a drive chain or a push bar arrangement can engage in the drive apertures and pull the product carrier along. In this case, the drivers can rest against the stop edges without slipping.

Since the product carrier has stop edges in and counter to the transport direction, it does not matter in which direction the product carrier is placed on the transport system or is introduced into the transport system.

The longitudinal extent of the drive apertures allows flexibility in the transport speed. A driver can therefore be moved within the drive aperture without advancing the product carrier. In this case, for example, the distance from other product carriers which are already being moved by parallel and simultaneously moved drivers can be changed.

The drive apertures of the two longitudinal-edge strips are opposite one another. The drive apertures are preferably equal in length and preferably equal in height. In this case, the length faces in the longitudinal direction and the height in a direction that is perpendicular to the longitudinal direction and perpendicular to the width direction.

Preferably, the drive apertures of the two longitudinal-edge strips are symmetrical with respect to a central plane of the product carrier in the longitudinal direction, which runs perpendicular to the alignment of the rectangular basic shape of the product carrier and has a normal in the width direction.

Product carriers of this type are suitable for being pulled along by drivers that are exactly opposite each other in the direction of transport.

The product carrier also has width-edge strips mutually opposing one another on the width sides. The width-edge strips preferably enclose a right angle with the upper side.

The width-edge strips each have at least one guide aperture. The guide apertures of the width-edge strips are open in the direction facing away from the upper side. They have a longitudinal extent of less than 10%, and preferably less than 5%, of the width of the product carrier.

The guide apertures of the two width-edge strips are opposite one another.

Opposite guide apertures are preferably equal in length and preferably equal in height. In this case, the longitudinal extent of the guide apertures points in the direction of the width extent of the product carrier, and the height points in a direction that is perpendicular to the longitudinal direction and perpendicular to the width direction. All guide apertures preferably have the same longitudinal extent and height.

The guide apertures of the two width-edge strips are preferably symmetrical with respect to a central plane of the product carrier, which is perpendicular to the alignment of the rectangular basic shape of the product carrier and perpendicular to the longitudinal direction.

A bar guide of a transport system, which runs along the transport direction, can engage in the guide apertures so that the product carrier is supported from the underside.

Each of the width-edge strips can have one to eight guide apertures for up to eight bar guides.

In regions of the transport system in which a force is exerted on the product carrier, the product carrier can preferably rest on more than one bar guide, and for this purpose has more than one guide aperture.

The product carrier has longitudinal-edge strips and width-edge strips. These stabilize the product carrier—particularly when it is made of plastic. At the same time, the apertures in the edge strips provide engagement options for a drive and for a guide.

At least one separating rib, which extends in the width direction and perpendicular to the longitudinal direction, can be arranged on the underside of the product carrier.

The separating rib forms at least two channels which are open in a direction pointing away from the upper side and along which air can be conducted.

In particular, the separating rib has a lower height than the height of the longitudinal-edge strips and/or the width-edge strips.

The separating rib stabilizes the product carrier. Air can be guided through the channels along the product carrier. In accordance with the alignment of the separating rib, the channels, like the separating rib, also run in the width direction, i.e., perpendicular to the longitudinal direction. Temperature-control air, e.g., cooling air, can therefore be blown onto the product carrier from the side during transport, which flows through the channels along the entire product carrier and controls the temperature of the transported product in the process.

The separating rib can have a material thickness of 1 mm to 4 mm and acts as a guide plate for air flowing through. The separating rib can have a material thickness which is thicker or thinner than the material thickness of the product carrier in the region of the longitudinal-edge strips and/or the width-edge strips.

Preferably, several—in particular, evenly-spaced—separating ribs are provided which form a plurality of channels.

The separating rib can have a smaller longitudinal extent than the width of the product carrier.

The separating rib can be arranged between the width-edge strips.

The height of the separating rib is preferably smaller than or equal to the height of the width-edge strips on the guide apertures. The separating rib is therefore not in the way when a bar guide running in the transport direction engages in the guide apertures. The product carrier then preferably rests on the bar guide in the region of the width-edge strips.

Reinforcing ribs which extend in the longitudinal direction and which in particular have a lower height than the separating rib can be attached in the channels. Preferably, several reinforcing ribs, arranged parallel to one another and also preferably evenly-spaced, are provided in each channel.

Reinforcing ribs are in particular arranged between separating ribs and run in particular perpendicular to the separating ribs.

In particular, the reinforcing ribs ensure further stabilization of the product carrier. The reinforcing ribs basically do not hinder an air flow through the channels, but ensure turbulence that promotes heat exchange between the air and the product carrier.

In an advantageous embodiment of the product carrier, the longitudinal-edge strips and/or the width-edge strips are beveled towards the upper side of the product carrier, and preferably along the entire length and/or width of the product carrier.

The beveled region of the width-edge strips preferably encloses an angle of between 30° and 60° with the longitudinal direction of the product carrier. Analogously, the beveled region of the longitudinal-edge strips preferably encloses an angle of between 30° and 60° with the width alignment of the product carrier.

The bevel is preferably formed circumferentially around the surface of the product carrier.

The product carriers can thereby be effectively stacked, since the longitudinal-edge strips and/or the width-edge strips of a product carrier can rest on the beveled regions of a product carrier arranged therebelow. The opposite bevels of a product carrier offer a guide for the resting longitudinal-edge strips and/or width-edge strips, so that a stable stack can arise.

Stacks of product carriers are formed, for example, when the product carriers are stored and are ready for use, or if the product carriers are cooled by filled alveoli.

Preferably, the longitudinal-edge strips, the width-edge strips, the drive apertures, and the separating ribs are designed such that cooling air can also be guided along the channels even in the stacked state.

The product carrier can comprise support strips which are each arranged parallel to the width-edge strips and which can have the same maximum height as the width-edge strips. The support strips can have apertures which are aligned with the guide apertures of the width-edge strips. The support strips preferably have just as many apertures as those of the width-edge strips. The apertures are in particular symmetrical to the guide apertures with respect to a plane which is perpendicular to the alignment of the rectangular basic shape of the product carrier and perpendicular to the longitudinal direction.

One or a plurality of alveoli can be arranged on the upper side of the product carrier. The alveoli are preferably recessed in the upper side surface. The upper side surface can have depressions which form the alveoli.

The product carrier is preferably designed in one piece. The product carrier can be an injection-molded part in which alveoli, longitudinal-edge strips, width-edge strips, separating rib, reinforcing ribs, and/or support strips are molded onto a rectangular plate component.

The part of the contour of the guide aperture which abuts the edge, facing away from the upper side, of the width-edge strips can enclose an angle of 85°-95° with the edge, facing away from the upper side, of the width-edge strips. The guide aperture is therefore steep enough at the edge that a bar guide experiences a lateral stop and cannot slip off.

The objects are also achieved by a transport device—in particular, in a plant for producing food products—with at least one product carrier as has been described above.

The transport device advantageously comprises at least one movable driver, which are designed to rest against one of the stop edges of the product carrier in order to pull the product carrier. The transport device preferably comprises driver pairs opposite with respect to the transport direction, which each engage in opposite drive apertures of a product carrier.

The transport device can comprise at least one section with at least one bar guide which engages in the guide apertures. The section preferably comprises one to eight bar guides running parallel to one another and in the transport direction.

The transport device can have sections with fewer and sections with more bar guides running parallel to one another, depending upon how much support a product carrier requires in the particular section.

In sections in which a pressure is exerted on the product carrier, e.g., by a licking roller, several parallel bar guides are preferably present.

The product carrier has at least as many guide apertures in the particular width-edge strips as the maximum number of parallel bar guides in a transport system.

The driver can be arranged on a transport chain or on a push bar arrangement.

The transport device can be designed to bring the product carrier from one processing station to a next processing station or to transport it within a processing station. The processing equipment may be a mold warmer, a cooling station, a casting station, a sleeve forming station, a cold stamping station, an opening forming station, a filling station, a loading station, a jogging station, a covering station, a licking station, a decorating station, a demolding station, a stacking and/or unstacking station, a spraying station, a printing station, a loading station, a packaging station, a film loading station, and/or a control station.

The transport device can comprise a robot assembly with at least one gripper. The gripper can engage in the guide apertures of the product carrier. For this purpose, the gripper can comprise a gripping strip on which pins are arranged which engage in the guide apertures of the product carrier. The gripper preferably has a number of pins which corresponds to the number of guide apertures in a width-edge strip.

An identifier for identifying the product carrier may be applied to the longitudinal-edge strip and/or the width-edge strip. For example, a code, and in particular a barcode, can be printed, etched, or scored. The transport device preferably comprises a reading device for detecting the identifier.

The invention is explained below in exemplary embodiments with reference to drawings. In the figures:

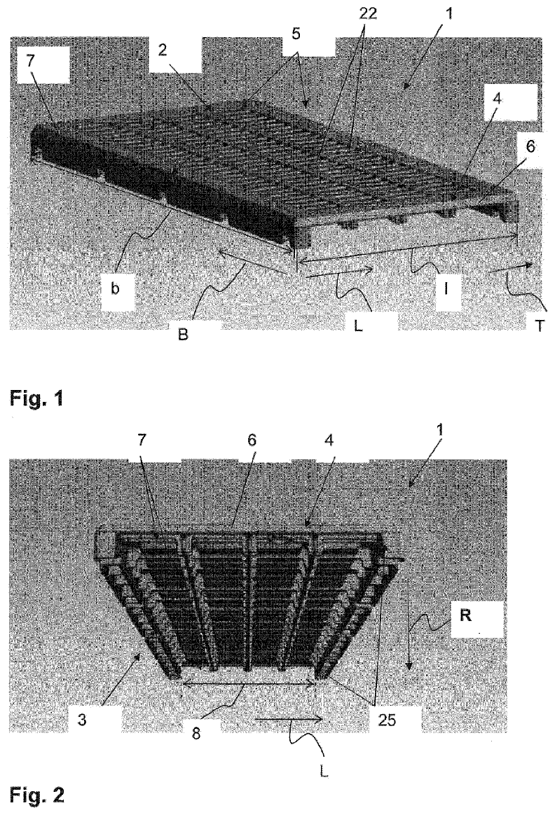

FIG. 1 shows a product carrier according to the invention in a first perspectival view;

FIG. 2 shows the product carrier according to the invention in a second perspectival view;

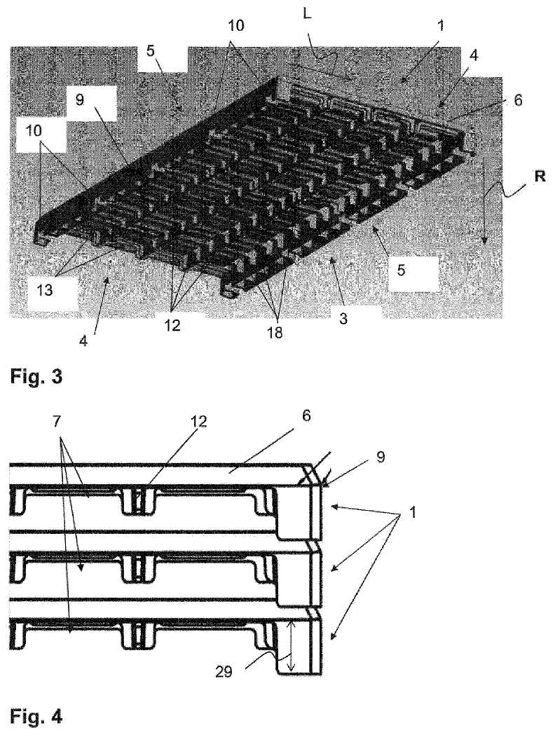

FIG. 3 shows the product carrier according to the invention in a third perspectival view;

FIG. 4 shows a stack of product carriers in a side view;

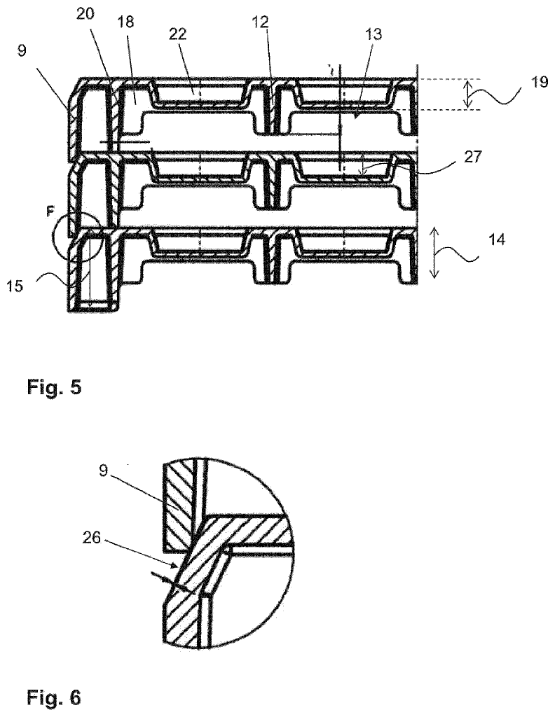

FIG. 5 shows a stack of product carriers in a sectional image;

FIG. 6 shows a detail from FIG. 5;

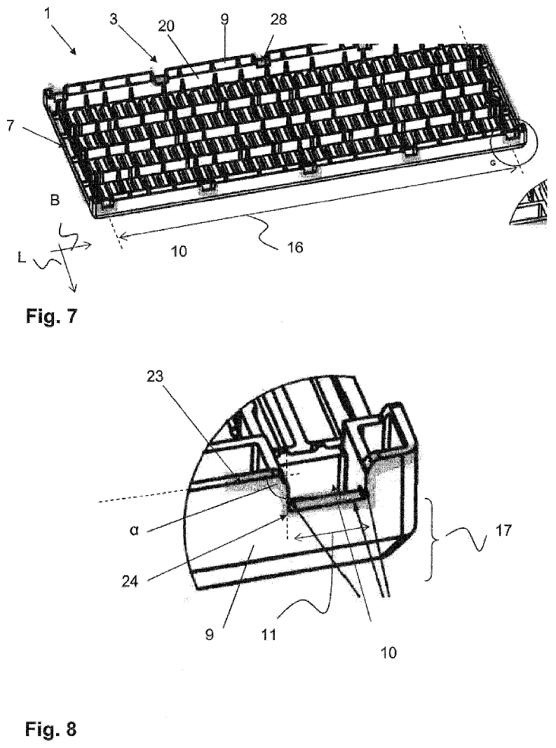

FIG. 7 shows the product carrier according to the invention in a fourth perspectival view;

FIG. 8 shows a detail from FIG. 7;

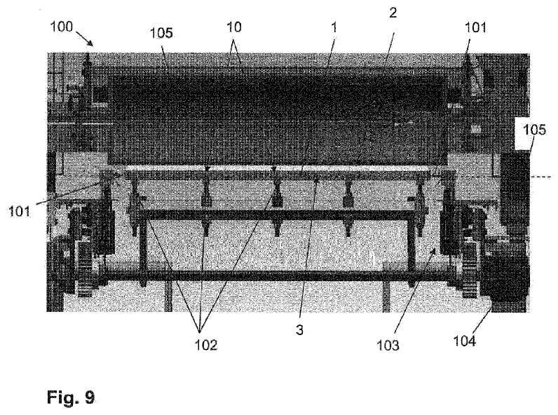

FIG. 9 shows a transport device according to the invention in a sectional view;

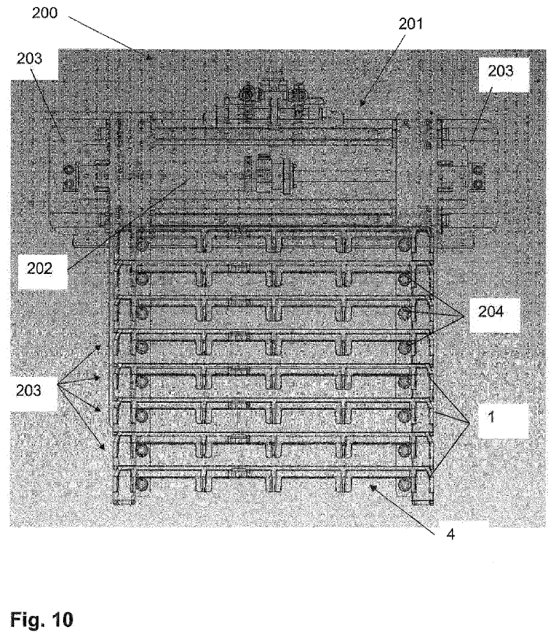

FIG. 10 shows a gripper of a first example of a robot assembly with a stack of product carriers in a sectional view;

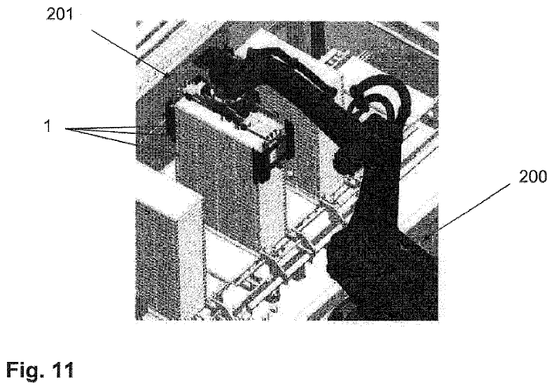

FIG. 11 shows a second example of a robot assembly.

FIG. 1 shows a product carrier 1 according to the invention in a first perspectival view, FIG. 2 shows the product carrier 1 in a second perspectival view, and FIG. 3 shows the product carrier 1 according to the invention in a third perspectival view.

FIG. 1 shows the upper side 2 of the product carrier 1, on which a plurality of alveoli 22 for inserting or filling in products is arranged. FIGS. 2 and 3 show the upper side 3 of the product carrier 1 opposite the upper side 2.

The product carrier 1 has a rectangular basic shape with longitudinal sides 4 which have a length l in a longitudinal direction L, wherein the longitudinal direction corresponds to the typical transport direction T. The product carrier 1 has width sides 5 which have a width b in a width direction B perpendicular to the longitudinal direction L.

On the longitudinal sides 4, mutually-opposing longitudinal-edge strips 6 are provided, each of which has a drive aperture 7.

The drive apertures 7 of the two longitudinal-edge strips 6 are open in a direction R facing away from the upper side 2 and have a longitudinal extent 8 of greater than 80% of the length l of the product carrier 1. In the and counter to the longitudinal direction L, the drive apertures 7 have stop edges 25, against which drivers 101 (see FIG. 9) can rest and pull or push the product carrier 1.

On the width sides 5, mutually-opposing width-edge strips 9 are provided (see FIG. 3) which each have five guide aperture 10 which are open in the direction R pointing away from the upper side 2.

Three separating ribs 12, which extend perpendicular to the longitudinal direction L, are arranged on the underside 3 of the product carrier 1. The separating ribs 12 separate channels 13 from one another which are open in the direction R pointing away from the upper side 2.

Reinforcing ribs 18 which extend in the longitudinal direction L are attached within the channels 13. These stabilize the product carrier 1.

FIG. 4 shows a stack of product carriers 1 in a side view. The longitudinal-edge strips 6 and the width-edge strips 9 are beveled towards the upper side 2 of the product carriers 1. As can be seen in FIG. 1, the longitudinal-edge strips 6 and the width-edge strips 9 are beveled along the entire length l and width b.

The drive apertures 7 have a clear height 29 which is large enough that cooling air can also flow through the channels 13 when the product carriers 1 are stacked.

FIG. 5 shows a stack of product carriers in a sectional view; FIG. 6 shows a detail from FIG. 5.

Support strips 20 which reinforce the product carrier 1 in the edge region are arranged parallel to the width-edge strips 9.

The separating ribs 12 have a lower height 14 than the maximum height 15 of the longitudinal-edge strips 6 and the width-edge strips 9. However, the height 14 of the separating ribs 12 is greater than the depth 27 of the alveoli 22. Therefore, the channels 13 form between the separating ribs 12 in such a way that cooling air can flow along the underside of the alveoli 22.

The width-edge strip 9 of an upper product carrier 1 sits on the beveled region 26 of the product carrier 1 located underneath. The product carrier 1 therefore has a fixed seat in the stack. The beveled region 26 is concave and hence easy to clean.

For the most part, the support ribs 18 have a height 19, which is smaller than the height 14 of the separating ribs 12, and therefore do not block the channels 13.

At the contact point to the separating ribs 12, the support ribs 18 have the same height 14 as the separating ribs 12, so that a solid connection exists.

FIG. 7 shows the product carrier 1 according to the invention in a fourth perspectival view of the underside, and FIG. 8 shows a detail from FIG. 7. The separating ribs 12 have a smaller longitudinal extent 16 in the width direction B than the width b of the product carrier 1 (see FIG. 1). The separating ribs therefore do not extend into the drive aperture 7 and do not hinder the space which the drivers (see FIG. 9) require.

The support bars 20 arranged parallel to the width-edge strips 9 have apertures 28 which are aligned with the guide aperture 10 in the width-edge strips 9 in the longitudinal direction L.

The height 14 of the separating ribs 12 (see FIG. 5) is also smaller than the height 17 of the width-edge strips 9 on the guide apertures 10. The separating ribs therefore also do not extend into the region which spans the apertures 28 and the guide apertures 10.

The apertures 28 and the guide apertures 10 thus provide a support surface for a bar guide 102 (see FIG. 9).

The apertures 28 and the guide apertures 10 have a width extent 11 of less than 10% of the width b of the product carrier 1 (see FIG. 1).

The part 24 of the contour of the guide aperture 10 which abuts the edge 23, facing away from the upper side 2, of the width-edge strips 9 encloses an angle α of about 90° with the edge 23, facing away from the upper side 2, of the width-edge strips 9.

The bar guide 102 (see FIG. 9) therefore has a firm hold in the guide recess 10, and the product carrier 1 cannot slip laterally.

FIG. 9 shows a transport device 100 according to the invention in a sectional view. In the transport device 100, product carriers 1 are transported in the transport direction T, which in this case is perpendicular to the illustration plane.

The transport device 100 comprises drivers 101 movable opposite the transport direction, which pull the product carrier 1. The drivers 101 are arranged on a push bar arrangement 103. The push bar arrangement 103 has a drive 104 that moves the drivers 101 in the transport direction, then moves them vertically away from a transport plane 105 in which the surface of the product carrier 1 is located, then moves them against the transport direction, and then moves them vertically towards the transport plane 105.

In this case, the drivers 101 can grip the next product carrier 1, which is entrained during the next forward movement of the drivers 1.

The transport device 100 comprises five bar guides 102 which each engage in the guide apertures 10 in the product carriers 1. The product carriers 1 therefore experience support on the underside 3 when they receive pressure on the upper side 2—for example, from a licking roller 105.

FIG. 10 shows a gripper 201 of a robot assembly 200 with a stack of product carriers 1 in a sectional view.

The gripper 201 comprises a drive unit 202 with which the distance between the gripper jaws 203 can be changed. The uppermost product carrier 1, which for example is to be lifted from the stack, can be clamped between the gripper jaws 203.

The gripper 201 can simultaneously pick up several product carriers 1, viz., up to ten product carriers 1. For this purpose, it has four pins 204 on each plane 203, wherein two bolts can be arranged on opposite sides of the product carrier 1, in order to receive the product carriers 1 individually. The bolts 204 are moved from the longitudinal side 4 under the product carriers 1.

FIG. 11 shows a second example of a robot assembly 200. The robot assembly 200 comprises a gripper 201 with which a plurality of stacked product carriers 1 can be fixed and transported.

The product carriers 1 can have a width extent 11 (see FIG. 7) of 272 mm to 1,500 mm and a longitudinal extent 8 (see FIG. 2) of 275 mm to 460 mm.

The product carriers 1 can contain or be made of plastic—in particular, polycarbonate—or metal.

The product carriers 1 can comprise 5 to 300 alveoli 22 (see FIG. 5).

1. A product carrier for transporting food products, and in particular chocolate products, in a transport device, the transport device in a plant for producing food products,
wherein the product carrier has an upper side for loading and/or inserting products and an underside opposite the upper side,
the product carrier has a rectangular basic shape with longitudinal sides which have a length in a longitudinal direction, and with width sides which have a width in a width direction perpendicular to the longitudinal direction,
wherein
the product carrier has, on the longitudinal sides, mutually-opposing longitudinal-edge strips, each of which has a drive aperture,
wherein the drive apertures of the two longitudinal-edge strips are open in a direction extending away from the upper side, have a longitudinal extent of greater than 50%, and preferably greater than 80%, of the length of the product carrier, and have stop edges in and counter to the longitudinal direction,
and, on the width sides, the product carrier has mutually-opposing width-edge strips which each have at least one guide aperture, wherein the guide apertures of the width-edge strips are open in a direction extending away from the upper side, and have a width extent of less than 10%, and preferably less than 5%, of the width of the product carrier.

2. The product carrier according to claim 1, wherein
at least one separating rib which extends perpendicularly to the longitudinal direction, is arranged on the underside of the product carrier and forms at least two channels which are open in a direction pointing away from the upper side and along which air can be conducted,
wherein the separating ribs have in particular a lower height than the height of the longitudinal-edge strips and/or the width-edge strips.

3. The product carrier according to claim 2, wherein the
separating rib has a smaller longitudinal extent than the width of the product carrier, and/or
the height of the separating rib is smaller than or equal to the height of the width-edge strips on the guide apertures.

4. The product carrier according to claim 2, wherein reinforcing ribs which extend in the longitudinal direction and which in particular have a lower height than the separating rib are attached in the channels.

5. The product carrier according to claim 1, wherein the longitudinal-edge strips and/or the width-edge strips are beveled towards the upper side of the product carrier, and preferably along the entire length and/or width.

6. The product carrier according to claim 1, wherein the product carrier comprises support bars which are each arranged parallel to the width-edge strips which preferably have just as many apertures as the width-edge strips.

7. The product carrier according to claim 1, wherein one or a plurality of alveoli is arranged on the upper side of the product carrier.

8. The product carrier according to claim 1,
wherein the length is shorter than the width.

9. The product carrier according to claim 1,
wherein each of the width-edge strips has one to eight guide apertures.

10. The product carrier according to claim 1,
wherein the part of the contour of the guide aperture which abuts the edge, facing away from the upper side, of the width-edge strips encloses an angle α of 85°-95° with the edge, facing away from the upper side, of the width-edge strips.

11. A transport device in a plant for producing food products, the transport device having at least one product carrier according to claim 1.

12. The transport device according to claim 11, comprising at least one movable driver which are designed to rest against one of the stop edges of the product carrier in order to pull the product carrier.

13. The transport device according to claim 11, comprising at least one section having at least one bar guide, and preferably three to eight bar guides, which engage in the guide aperture.

14. The transport device according to claim 12, wherein the driver is arranged on a push bar arrangement.

15. The transport device according to claim 1, comprising a robot assembly having a gripper which engages in the guide apertures of the product carrier.
